(19) United States
(12) Patent Application Publication
(10) Pub. No.: US 2006/0083483 A1
(43) Pub. Date: Apr. 20, 2006

(54) Program recording device utilizing electronic program guide

(75) Inventor: Takuya Suzuki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/248,486

(22) Filed: Oct. 12, 2005

(30) Foreign Application Priority Data
Oct. 18, 2004 (JP) 2004-302560

(51) Int. Cl. H04N 5/76; H04N 5/445; H04N 5/91; G06F 13/00; G06F 3/00

(52) U.S. Cl. 386/83; 725/58

(57) ABSTRACT

An operation input unit receives an instruction for unattended recording of a program on a designated broadcast channel at a designated broadcast time. A program recording reserving unit refers to an electronic program guide, and produces a program recording reservation list bearing, as a time of programmed recording, a different broadcast time different from a designated broadcast time if a program of the same content as the program indicated for the programmed recording will be broadcast at the different time different from the designated broadcast time, and the different time is during a predetermined time period. The program recording unit records the program based on the program recording reservation list.

### BACKGROUND OF THE INVENTION

1. Field of the Invention

The present invention relates to a program recording device, and particularly to a program recording device utilizing an Electronic Program Guide (EPG).

2. Description of the Background Art

A technology of transmitting program data from a broadcasting station together with EPGs representing contents of programs has been spreading. For receivers, such a technology has been proposed that allows searching of a desired program from an EPG by using a character string of a program title as a search key.

For example, Japanese Patent Laying-Open No. 2000-295538 has disclosed the following receiver. The receiver compares program content information transmitted thereto with program content information of a program already stored in a preselected time overlap determining unit. When the receiver detects the selected program having an overlapping broadcast time, the receiver searches for a program that has program content information of the same program title as the program having program content information transmitted from a substitute program indicating unit, and has the broadcast time not overlapping a broadcast time of the program having the transmitted program content information. When the intended program is found, a substitute program list is displayed on a display unit so that a viewer can select it for recording reservation.

Thereby, it is possible to prevent a situation that a plurality of programs are preselected for recording at the same broadcast time.

If the programs of the same contents will be broadcast for the plurality of time periods, respectively, it is preferable or desirable to select a specific time period for recording in some cases. For example, since the electricity charge is low during the midnight time period, recording during the midnight time period is more economical than recording during the daytime.

However, Japanese Patent Laying-Open No. 2000-295538 has not disclosed a manner of giving higher priority to preselection of the record time during the predetermined time period.

Accordingly, an object of the invention is to provide a program recording device which can preselect a record time of the program during a predetermined time period on a priority basis in the case where a program of the same contents will be broadcast during a plurality of time periods.

### SUMMARY OF THE INVENTION

The invention provides a program recording device for accepting indication for programmed recording of a program on a broadcast channel designated by a user at a broadcast time designated by the user based on a received electronic program guide, and performing recording of the program based on a program recording reservation list prepared by the indication, including: a program recording reserving unit referring to the electronic program guide, setting the program indicated for the programmed recording and one or more program(s) of the same contents as the indicated program as reservation candidate programs, deleting the reservation candidate program of the broadcast time overlapping a broadcast time of another record-reserved program from a group of the reservation candidate programs, selecting the program of the broadcast time during a predetermined time period from the reservation candidate program(s) after the deletion, and producing the program recording reservation list bearing, as a time of programmed recording, the broadcast time of the selected program instead of the designated broadcast time; a program recording unit recording the program based on the program recording reservation list; a program table update determining unit determining update or non-update of the received electronic program guide; a program title correspondence storing unit storing a correspondence between the program title before the update and the program title of the same program after the update; an identical program determining unit performing determination about the programs of the same broadcast time and the same broadcast channel when the electronic program guide is updated, by determining whether a character string representing the program title in the non-updated electronic program guide is a part of the program title in the updated electronic program guide or not, and writing the program title before the update and the program title after the update in a fashion corresponding to each other in the program title correspondence storing unit when the correspondence is present; a program searching unit determining whether a designated program title is stored in the program title correspondence storing unit or not, when search for the program based on the designated program title is requested, and searching for the program included in the received electronic program guide by using the designated program title and the program title stored corresponding to the designated program title when the designated program title is stored in the program title correspondence storing unit; and an electronic program guide display control unit displaying the last received electronic program guide when the display of the electronic program guide is requested, wherein the electronic program guide display control unit specifies the program title stored in the program title correspondence storing unit among the program titles of the programs in the last received electronic program guide, and displays the stored corresponding program title instead of the specified program title when the specified program title is shorter than the stored corresponding program title.

Also, the invention provides a program recording device for accepting indication for programmed recording of a program on a broadcast channel designated by a user at a broadcast time designated by the user based on a received electronic program guide, and performing recording of the program based on a program recording reservation list prepared by the indication, including: a program recording reserving unit referring to the electronic program guide, and producing a program recording reservation list bearing, as a time of programmed recording, a different broadcast time different from the designated broadcast time if a program of the same content as the program indicated for the programmed recording will be broadcast at the different time different from the designated broadcast time, and the different time is during a predetermined time period; and a program recording unit recording the program based on the program recording reservation list.

Preferably, the program recording reserving unit sets the program indicated for the programmed recording and one or more program(s) of the same contents as the indicated program as reservation candidate programs, deletes the reservation candidate program of the broadcast time overlapping a broadcast time of another record-reserved program from a group of the reservation candidate programs, selects the program of the broadcast time during a predetermined time period from the reservation candidate program(s) after the deletion, and produces the program recording reservation list bearing, as a time of programmed recording, the broadcast time of the selected program instead of the designated broadcast time.

Preferably, the program recording device further includes: a program table update determining unit determining update or non-update of the received electronic program guide; a program title correspondence storing unit storing a correspondence between the program title before the update and the program title of the same program after the update; an identical program determining unit performing determination about the programs of the same broadcast time and the same broadcast channel when the electronic program guide is updated, by determining whether a correspondence is present between the program titles in the updated and non-updated electronic program guides or not, and writing the program title before the update and the program title after the update in a fashion corresponding to each other in the program title correspondence storing unit when the correspondence is present; and a program searching unit determining whether a designated program title is stored in the program title correspondence storing unit or not, when search for the program based on the designated program title is requested, and searching for the program included in the received electronic program guide by using the designated program title and the program title stored corresponding to the designated program title when the designated program title is stored in the program title correspondence storing unit.

Preferably, the identical program determining unit performs determination about the programs of the same broadcast time and the same broadcast channel, and determines that the correspondence is present when a character string representing the program title in the non-updated electronic program guide is a part of the program title in the updated electronic program guide.

Preferably, the program recording device further includes: an electronic program guide display control unit displaying the last received electronic program guide when the display of the electronic program guide is requested. The electronic program guide display control unit specifies the program title stored in the program title correspondence storing unit among the program titles of the programs in the last received electronic program guide, and displays the stored corresponding program title instead of the specified program title when the specified program title is shorter than the stored corresponding program title.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a program recording device according to an embodiment of the invention.

FIG. 2 illustrates, by way of example, new program titles stored corresponding to respective old program titles in a program title correspondence storing unit 11.

FIG. 3 is a flowchart illustrating an operation procedure of identical program title determination.

FIG. 4 is a flowchart illustrating an operation procedure of program recording reservation.

FIG. 5 illustrates a specific example of the program recording reservation.

### DESCRIPTION OF THE PREFERRED EMBODIMENTS

Embodiments of the invention will now be described with reference to the drawings. In the following description, the same or corresponding portions bear the same reference numbers, and description thereof is not repeated.

(Structure of a Program Recording Device)

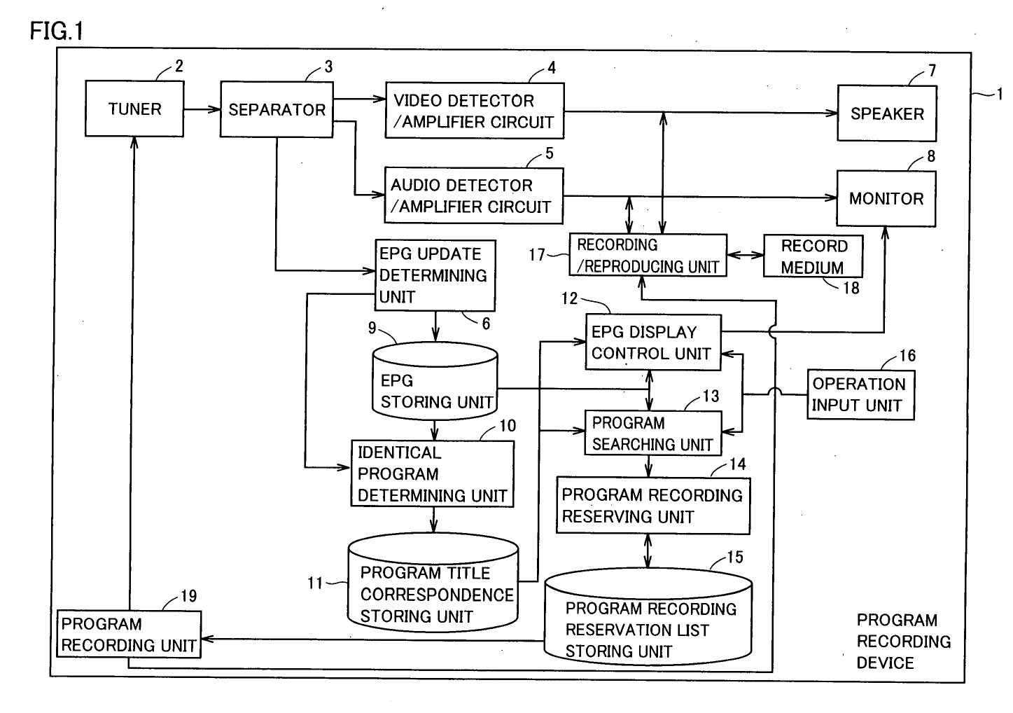

FIG. 1 shows a structure of a program recording device according to an embodiment of the invention.

Referring to FIG. 1, a program recording device 1 includes a tuner 2, a separator 3, an audio detector/amplifier circuit 4, a video detector/amplifier circuit 5, a recording/reproducing unit 17, a record medium 18, a monitor 8, a loud speaker 7, an operation input unit 16, an EPG storing unit 9, an EPG display control unit 12, an EPG update determining unit 6, an identical program determining unit 10, a program title correspondence storing unit 1, a program searching unit 13, a program recording reserving unit 14, a program recording reservation list storing unit 15 and a program recording unit 19.

Tuner 2 receives a broadcast signal on a designated channel.

Separator 3 separates a video signal, an audio signal and an EPG from the received broadcast signal.

Audio detector/amplifier circuit 4 detects and amplifies the audio signal provided from separator 3 for providing it to speaker 7.

Video detector/amplifier circuit 5 detects and amplifies the video signal provided from separator 3 for providing it to monitor 8.

Recording/reproducing unit 17 can record the video signal provided from video detector/amplifier circuit 5 and the audio signal provided from audio detector/amplifier circuit 4, and can also reproduce the video and audio signals, which are recorded on record medium 18, on monitor 8 and from speaker 7.

Record medium 18 is formed of a hard disk, a video tape or a DVD (Digital Versatile Disk), and can carry the audio signal provided from audio detector/amplifier circuit 4 and the video signal provided from video detector/amplifier circuit 5.

Monitor 8 displays the video signal provided from the video detector circuit and the EPG provided from EPG display control unit 12.

Speaker 7 outputs the audio signal provided from the audio detector circuit.

Operation input unit 16 accepts user's requests for program recording reservation, program search and EGP display.

EPG storing unit 9 stores a received latest EPG. The EPG includes the information about programs for two weeks, and specifically includes information such as program titles, broadcast times (broadcast dates, broadcast start times and broadcast end times), broadcast channels, reservation codes and categories. The EPG is updated at predetermined time intervals (e.g., four times a day).

EPG update determining unit 6 refers to the EPG provided from separator 3 and the EPG stored in EPG storing unit 9, and determines whether the EPG is already updated or not. When updated, EPG update determining unit 6 writes the new EPG in EPG storing unit 9. When the EPG is updated, and there is a change in program title of the program at the same broadcast time on the same broadcast channel, EPG update determining unit 6 causes identical program determining unit 10 to determine the program title.

When the electronic program guide is updated, identical program determining unit 10 performs determination about program at the same broadcast time on the same broadcast channel, and specifically determines whether there is a correspondence between the program title in the non-updated EPG (i.e., EPG which is not yet updated) and the program title in the updated EPG or not, and for example whether a character string of the program title in the non-updated EPG is a part of the character string of the program title of the updated EPG or not. When identical program determining unit 10 determines that there is a correspondence, it writes the program title (old program title) in the non-updated EPG and the program title (new program title) in the updated EPG into program title correspondence storing unit 11 while keeping a correspondence therebetween. When identical program determining unit 10 determines that there is no correspondence between the program title in the non-updated EPG and the program title in the updated EPG, it recognizes that the program before the update is different from the program after the update, and does not perform writing into program title correspondence storing unit 11.

Program title correspondence storing unit 11 stores the correspondence between the old and new program titles (i.e., program titles before and after the update) of the program of which program title is updated in the EPG.

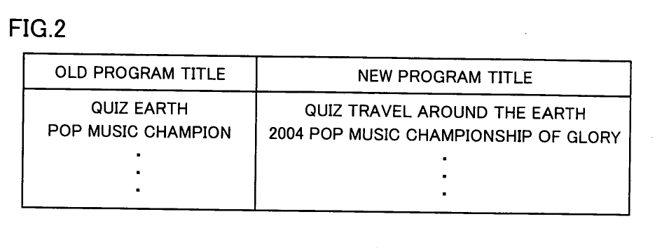

FIG. 2 illustrates, by way of example, new program titles stored corresponding to respective old program titles in program title correspondence storing unit 11.

Referring to FIG. 2, a new program title “QUIZ TRAVEL AROUND THE EARTH” including a character string “QUIZ EARTH” in an old program title is stored corresponding to the character string “QUIZ EARTH” in the old program title.

Corresponding to a character string “POP MUSIC CHAMPION” in an old program title, program title correspondence storing unit 11 has stored a new program title “2004 POP MUSIC CHAMPIONSHIP OF GLORY” including the character string “POP MUSIC CHAMPION” in the old program title.

EPG display control unit 12 displays the latest EPG stored in EPG storing unit 9 when it is requested to display the EPG via operation input unit 16. When EPG display control unit 12 displays the latest EPG, it specifies the program title stored in program title correspondence storing unit 11 among the program titles of the programs included in the latest EPG. When the specified program title is shorter (i.e., smaller in number of characters) than the stored program title corresponding to it, EPG display control unit 12 displays the stored corresponding program title (i.e., title having a longer title) instead of the specified program title.

When program searching unit 13 is requested via operation input unit 16 to search for the designated program, and the designated program title is stored in the program title correspondence storing unit 11, program searching unit 13 searches the EPG stored in EPG storing unit 9 for the program according to the designated program title and the program title stored corresponding to the designated program title.

When program searching unit 13 is requested via operation input unit 16 to record the program, it specifies the program title of the program designated by the user. When program title correspondence storing unit 11 has stored the specified program title, program searching unit 13 determines whether a program of the same program title as the specified program title or a program of the same program title as the program title stored corresponding to the specified program title is present in the EPG stored in EPG storing unit 9 or not.

Program recording reserving unit 14 receives a notification from program searching unit 13 about the program of the same program title as the program, of which recording is requested by the user, and the program of the same program title as the program corresponding to the program, of which recording is requested.

When program recording reserving unit 14 receives the notification of the program of the same program title, it selects the notified program and the original program, which is designated for the programmed or unattended recording by the user, as the reservation candidate programs. Program recording reserving unit 14 refers to the program recording reservation list, and determines for each of the reservation candidate programs whether the broadcast time (broadcast data, broadcast start time and broadcast end time) overlaps the broadcast time (broadcast data, broadcast start time and broadcast end time) of the program already selected for recording. When these times overlap together, the program is deleted from the reservation candidate program group. When the reservation candidate programs include the program(s) of which broadcast time(s) (broadcast data, broadcast start time and broadcast end time) are included in a midnight time period (e.g., from 2:00 a.m. to 4:00 a.m.), program recording reserving unit 14 selects one of the program(s) of the above broadcast time(s), and registers the broadcast time (broadcast data, broadcast start time and broadcast end time) and the broadcast channel of the program thus selected in the program recording reservation list. When there is no program during the midnight time period, program recording reserving unit 14 selects the program of the broadcast start time closest to the current time, and registers the broadcast time (broadcast data, broadcast start time and broadcast end time) and the broadcast channel of the program thus selected in the program recording reservation list.

The program recording reservation list storing unit 15 stores the program recording reservation list including the broadcast time (broadcast data, broadcast start time and broadcast end time) and the broadcast channel of each of the programmed recording target programs.

Program recording unit 19 instructs tuner 2 to receive the broadcast signals of each program, which is determined in the program recording reservation list, for a period from the broadcast start time to the broadcast end time, and also instructs recording/reproducing unit 17 to record the video and audio signals, where are detected and amplified, on record medium 18.

(Operation)

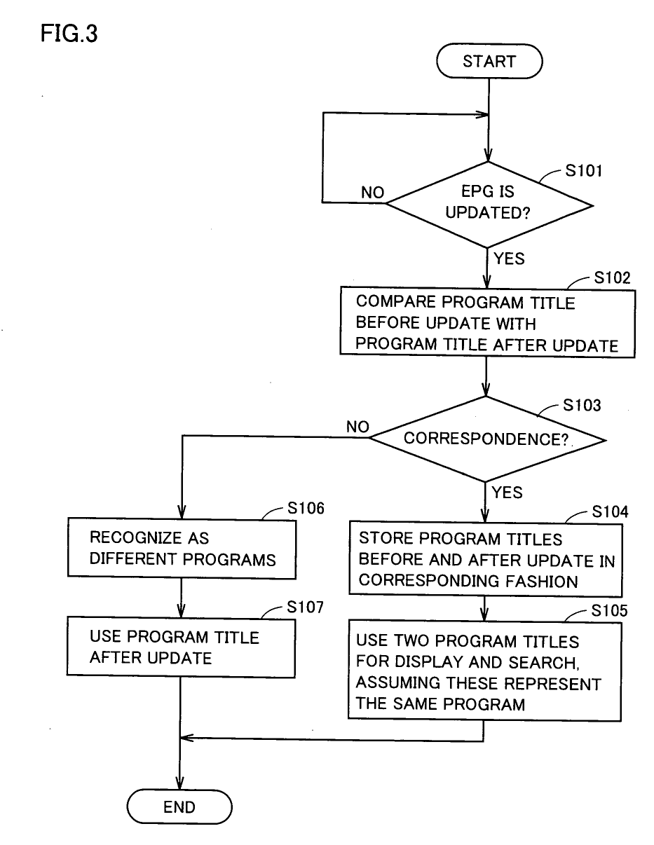

FIG. 3 is a flowchart illustrating an operation procedure of identical program title determination.

Referring to FIG. 3, EPG update determining unit 6 first determines whether the EPG is updated or not, and a program of a changed program title is present or not (step S101).

When the EPG is changed and a program having a changed program title is present (YES in step S101), identical program determining unit 10 compares the program title of the program in the EPG before the update and the program title in the EPG after the update (step S102).

When identical program determining unit 10 determines that there is a correspondence between the program title in the EPG before the update and that after the update and, for example, when a character string of the program title in the EPG before the update is a part of the character string of the program title in the EPG after the update (YES in step S103), identical program determining unit 10 writes the old and new program titles, i.e., the program title in the EPG before the update and that after the update in a fashion corresponding to each other into program title correspondence storing unit 11 (step S104).

When the user requests the search for the program by indicating the program title, which is stored in program title correspondence storing unit 11, program searching unit 13 searches the EPG stored in EPG storing unit 9 for the program bearing the designated program title and the program title stored corresponding to the designated program title.

When the user requests the display of the EPG, EPG display control unit 12 displays the latest EPG stored in EPG storing unit 9. When displaying the latest EPG, EPG display control unit 12 specifies the program title stored in program title correspondence storing unit 11 among the program titles of the programs stored in the latest EPG. When the specified program title is shorter than the corresponding stored program title, EPG display control unit 12 displays the stored corresponding program title instead of the specified program title (step S105).

Conversely, when identical program determining unit 10 determines that there is no correspondence between the program titles before and after the update (NO in step S103), it recognizes that the program before the update is different from the program after the update, and does not perform the writing into program title correspondence storing unit 11 (step S106).

When the user requests the program search by designating the program title, program searching unit 13 searches for the program bearing the designated program title in the EPG stored in EPG storing unit 9.

When the user requests the display of the EPG, EPG display control unit 12 displays the latest EPG stored in EPG storing unit 9 as it is (step S107).

(Operation)

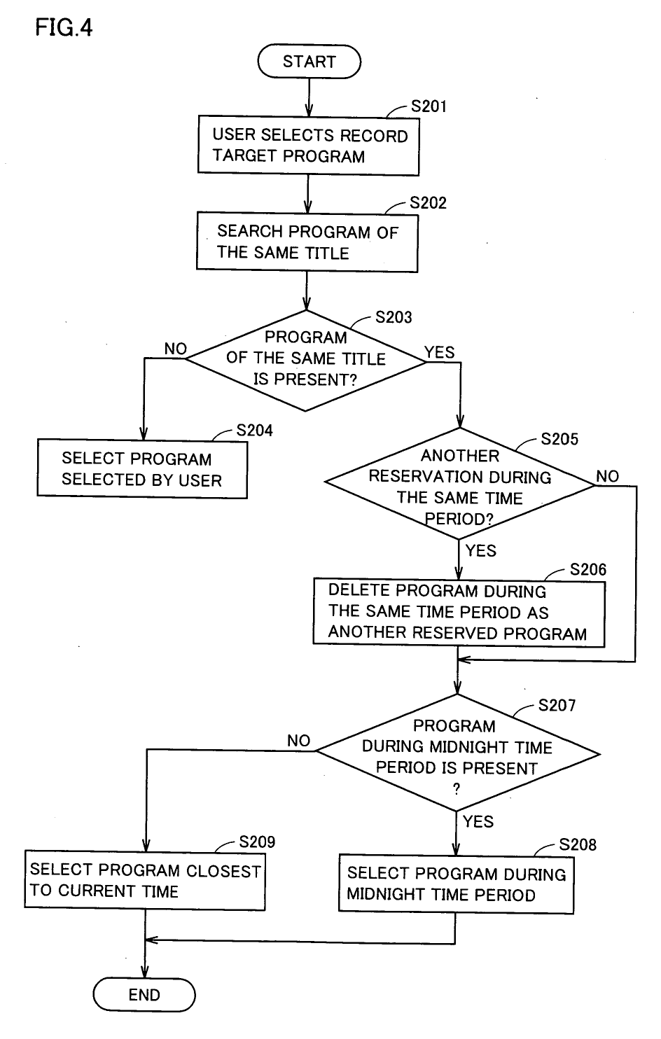

FIG. 4 is a flowchart illustrating an operation procedure of the program recording reservation.

Referring to FIG. 4, the user requests the program recording reservation by designating the program at one position in the EPG displayed on monitor 8 via operation input unit 16 (step S201).

Then, program searching unit 13 specifies the program title of the program designated by the user. When program title correspondence storing unit 11 has stored the specified program title, program searching unit 13 determines whether the EPG stored in EPG storing unit 9 includes either the program of the same program title as the specified program title or the program of the same program title as the program title stored corresponding to the specified program title or not (step S202).

When the program of the same program title is not present (NO in step S203), program recording reserving unit 14 specifies the broadcast time (broadcast date, broadcast start time and broadcast end time) and the broadcast channel of the program at the location designated by the user, and registers them in the program recording reservation list (step S204).

When the program of the same title is present (YES in step S203), program recording reserving unit 14 selects the program of the same title and the original program, which is designated by the user for the recording reservation, as the reservation candidate programs. Program recording reserving unit 14 refers to the program recording reservation list, and checks each of the reservation candidate programs by determining whether the broadcast time (broadcast date, broadcast start time and broadcast end time) of the program overlaps the broadcast time (broadcast date, broadcast start time and broadcast end time) of the program already registered for the programmed recording or not. When overlapping occurs (YES in step S205), the program in question is deleted from the group of the reservation candidate programs (step S206).

When the reservation candidate programs include the program(s) of which broadcast time(s) (broadcast data, broadcast start time and broadcast end time) are included in a midnight time period, e.g., from 2:00 a.m. to 4:00 a.m. (YES in step S207), program recording reserving unit 14 selects one of the above program(s), and registers the broadcast time (broadcast data, broadcast start time and broadcast end time) and the broadcast channel of the program thus selected in the program recording reservation list (step S208).

When no program is included in the midnight time period (NO in step S207), program recording reserving unit 14 selects the program of the broadcast start time closest to the current time, and registers the broadcast time (broadcast data, broadcast start time and broadcast end time) and the broadcast channel of the program thus selected in the program recording reservation list (step S209).

(Specific Example)

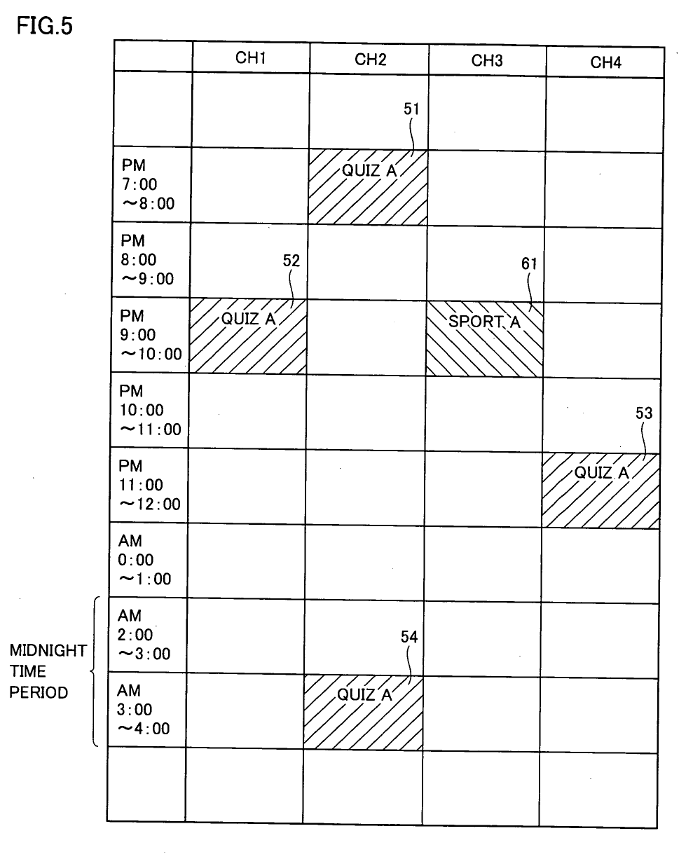

FIG. 5 illustrates a specific example of the program recording reservation.

Referring to FIG. 5, it is assumed that the user requests the recording of a program 51 in the EPG.

Since program title correspondence storing unit 11 has not stored “QUIZ A” of program 51, program searching unit 13 searches for the program of the program title “QUIZ A” in the EPG.

Then, program recording reserving unit 14 sets found programs 52, 53 and 54 as well as original program 51, of which recording is requested by the user, as the reservation candidate programs.

Since program 52 among the reservation candidate programs has the broadcast time (9:00-10:00) overlapping the broadcast time (9:00-10:00) of a program 61 already registered for unattended recording, program recording reserving unit 14 deletes program 52 from the reservation candidate program group.

Among reservation candidate programs 51, 53 and 54, program 54 has the broadcast time (3:00-4:00) during the midnight time period (2:00-4:00). Therefore, program recording reserving unit 14 registers the broadcast time (3:00-4:00) and the broadcast channel (CH2) of program 54 in the program recording reservation list.

As described above, the program recording device according to the embodiment of the invention can select the midnight time period for the record time of the program on a priority basis when the same program will be broadcast during a plurality of time periods.

(Modification)

The invention is not restricted to the above embodiment, and may include, e.g., the following modifications.

(1) When no program will be broadcast during the midnight time period, the program is selected for recording as follows.

According to the embodiment of the invention, if no program is present during the midnight time period, the program of the broadcast time closest to the current time is selected. However, this is not restrictive. The program at the position, which was initially selected in the displayed EPG by the user, may be selected for the recording.

(2) Program Recording Reservation

According to the embodiment of the invention, the reservation candidate programs include the user-requested program, i.e., the program of which recording is requested by the user, the program of the same program title as the user-requested program and the program of the same program title as the program which is stored corresponding to the program title of the user-requested program in the program title storing unit. However, this is not restrictive. Only the user-requested program and the program of the same program title as the user-requested program may be selected as the reservation candidate programs.

(3) Determination of the Same Program

According to the embodiment of the invention, when the character string of the program title before the update is a part of the program title after the update, i.e., when the program title after the update includes all the characters of the program title before the update, it is determined that a correspondence is present between the program titles before and after the update. However, the criterion of the correspondence is not restricted to this. For example, when the program title after the update contains 90% or more of the character string of the program title before the update, it may be determined that the correspondence is present between the programs before and after the update. Alternatively, when the Kanjis included in the program title before the update match Kanjis included in the program title after the update, it may be determined that the correspondence is present between the programs before and after the update.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A program recording device for accepting indication for programmed recording of a program on a broadcast channel designated by a user at a broadcast time designated by the user based on a received electronic program guide, and performing recording of the program based on a program recording reservation list prepared by the indication, comprising:
a program recording reserving unit referring to said electronic program guide, setting the program indicated for the programmed recording and one or more program(s) of the same contents as said indicated program as reservation candidate programs, deleting the reservation candidate program of the broadcast time overlapping a broadcast time of another record-reserved program from a group of said reservation candidate programs, selecting the program of the broadcast time during a predetermined time period from the reservation candidate program(s) after said deletion, and producing the program recording reservation list bearing, as a time of programmed recording, the broadcast time of said selected program instead of said designated broadcast time;
a program recording unit recording the program based on said program recording reservation list;
a program table update determining unit determining update or non-update of said received electronic program guide;
a program title correspondence storing unit storing a correspondence between the program title before the update and the program title of the same program after the update;
an identical program determining unit performing determination about the programs of the same broadcast time and the same broadcast channel when the electronic program guide is updated, by determining whether a character string representing the program title in the non-updated electronic program guide is a part of the program title in the updated electronic program guide or not, and writing the program title before the update and the program title after the update in a fashion corresponding to each other in the program title correspondence storing unit when said correspondence is present;
a program searching unit determining whether a designated program title is stored in said program title correspondence storing unit or not, when search for the program based on said designated program title is requested, and searching for the program included in said received electronic program guide by using said designated program title and the program title stored corresponding to said designated program title when said designated program title is stored in said program title correspondence storing unit; and
an electronic program guide display control unit displaying the last received electronic program guide when the display of the electronic program guide is requested, wherein
said electronic program guide display control unit specifies the program title stored in said program title correspondence storing unit among the program titles of the programs in said last received electronic program guide, and displays said stored corresponding program title instead of said specified program title when said specified program title is shorter than the stored corresponding program title.

2. A program recording device for accepting indication for programmed recording of a program on a broadcast channel designated by a user at a broadcast time designated by the user based on a received electronic program guide, and performing recording of the program based on a program recording reservation list prepared by the indication, comprising:
a program recording reserving unit referring to said electronic program guide, and producing a program recording reservation list bearing, as a time of programmed recording, a different broadcast time different from said designated broadcast time if a program of the same content as the program indicated for said programmed recording will be broadcast at said different time different from said designated broadcast time, and the different time is during a predetermined time period; and
a program recording unit recording the program based on said program recording reservation list.

3. The program recording device according to claim 2, wherein
said program recording reserving unit sets the program indicated for the programmed recording and one or more program(s) of the same contents as said indicated program as reservation candidate programs, deletes the reservation candidate program of the broadcast time overlapping a broadcast time of another record-reserved program from a group of said reservation candidate programs, selects the program of the broadcast time during a predetermined time period from the reservation candidate program(s) after said deletion, and produces the program recording reservation list bearing, as a time of programmed recording, the broadcast time of said selected program instead of said designated broadcast time.

4. The program recording device according to claim 2, further comprising:
a program table update determining unit determining update or non-update of said received electronic program guide;
a program title correspondence storing unit storing a correspondence between the program title before the update and the program title of the same program after the update;
an identical program determining unit performing determination about the programs of the same broadcast time and the same broadcast channel when the electronic program guide is updated, by determining whether a correspondence is present between the program titles in the updated and non-updated electronic program guides or not, and writing the program title before the update and the program title after the update in a fashion corresponding to each other in the program title correspondence storing unit when said correspondence is present; and
a program searching unit determining whether a designated program title is stored in said program title correspondence storing unit or not, when search for the program based on said designated program title is requested, and searching for the program included in said received electronic program guide by using said designated program title and the program title stored corresponding to said designated program title when said designated program title is stored in said program title correspondence storing unit.

5. The program recording device according to claim 4, wherein
said identical program determining unit performs determination about the programs of the same broadcast time and the same broadcast channel, and determines that said correspondence is present when a character string representing the program title in said non-updated electronic program guide is a part of the program title in said updated electronic program guide.

6. The program recording device according to claim 4, further comprising:
an electronic program guide display control unit displaying the last received electronic program guide when the display of the electronic program guide is requested, wherein
said electronic program guide display control unit specifies the program title stored in said program title correspondence storing unit among the program titles of the programs in said last received electronic program guide, and displays said stored corresponding program title instead of said specified program title when said specified program title is shorter than the stored corresponding program title.
